(19) United States
(12) Patent Application Publication
(10) Pub. No.: US 2024/0001574 A1
(43) Pub. Date: Jan. 4, 2024

(54) CUTTER STRUCTURE, TRAVELLING CARRIAGE STRUCTURE, AND CUTTING MACHINE

(71) Applicant: SHENZHEN JINGWEIXIAN TECHNOLOGY CO., LTD, SHENZHEN (CN)

(72) Inventor: JIANGLIN LI, SHENZHEN (CN)

(21) Appl. No.: 17/951,117

(22) Filed: Sep. 23, 2022

(30) Foreign Application Priority Data
Jul. 1, 2022 (CN) 202221697210.7
Jul. 1, 2022 (CN) 202221705779.3

(51) Int. Cl. B26D 1/56; B26D 7/00

(52) U.S. Cl. CPC B26D 1/56; B26D 2007/0012; B26D 7/00

(57) ABSTRACT

A cutter structure, a travelling carriage structure, and a cutting machine are provided. The cutter structure is applied to a travelling carriage assembly, and includes a first drive assembly and a cutter. The first drive assembly can drive the cutter to rotate relative to the first drive assembly. The travelling carriage structure includes a travelling carriage assembly and the cutter structure. The cutter structure is arranged on the travelling carriage assembly, and the travelling carriage assembly can drive the cutter structure to move. The cutting machine includes the travelling carriage structure and a controller configured to control rotation of the first drive assembly to change an angle of the cutter.

### CROSS REFERENCE TO RELATED APPLICATIONS

The present disclosure claims priority to Chinese Patent Application No. 202221697210.7, filed Jul. 1, 2022, entitled “CUTTER STRUCTURE, TRAVELLING CARRIAGE STRUCTURE, AND CUTTING MACHINE”, and Chinese Patent Application No. 202221705779.3, filed Jul. 1, 2022, entitled “CUTTING MACHINE”, which are hereby incorporated by reference herein as if set forth in their entireties.

### BACKGROUND

### 1. Technical Field

The present disclosure relates to the technical field of cutting machines, and particular to a cutter structure, a travelling carriage structure, and a cutting machine.

### 2. Description of Related Art

When a cutting machine is used for cutting materials, a cutter is driven by a travelling carriage of the cutting machine to move so as to cut the materials.

Generally, the cutter of the cutting machine can only be moved along the X axis or the Y axis, namely, along a straight line, to cut the material to be cut to have a rectangular shape. In the conventional technology, there are rotary cutting machines capable of actively changing the direction of a cutter to cut materials to have different patterns, such as circles.

The cutter of the conventional rotary cutting machine is connected to a motor in a travelling carriage through a transmission structure, and the cutter is driven to rotate through the rotation of the motor in the travelling carriage. However, in the conventional rotary cutting machine, when the motor fails and needs to be replaced, due to that the cutter is connected to the motor through the transmission structure, the transmission structure and the cutter need to be removed first, and then the cutting machine is disassembled to remove and replace the motor, which is complex in operation.

### BRIEF DESCRIPTION OF THE DRAWINGS

In order to more clearly illustrate the technical solutions in this embodiment disclosure, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a schematic view of a cutter structure according to an embodiment.

FIG. 2 is an exploded view of a cutter structure according to an embodiment.

FIG. 3 is a cross-sectional view of a cutter structure according to an embodiment.

FIG. 4 is a partial schematic view of a cutter structure according to an embodiment.

FIG. 5 is a partial schematic view of a travelling carriage structure according to an embodiment.

FIG. 6 is a partial schematic view of a travelling carriage structure according to an embodiment from another perspective.

FIG. 7 is a partial schematic view of a travelling carriage structure according to an embodiment from yet another perspective.

FIG. 8 is a partially enlarged view of FIG. 7.

FIG. 9 is an overall view of a cutting machine according to an embodiment.

FIG. 10 is an overall view of a cutting machine according to an embodiment from another perspective.

FIG. 11 is a cross-sectional view of FIG. 10 taken along line X.

Reference numerals are as follows.

10, cutting machine; 1, cutter structure; 11, first drive assembly; 12, cutter; 13, motor housing; 14, coupling; 15, cutter handle; 16, cutter head; 17, elastic member; 18, cutter housing; 19, bearing; 181, reflecting plane; 2, travelling carriage assembly; 21, second drive assembly; 22, first transmission assembly; 221, first gear; 222, second gear; 223, third gear; 224, rack; 23, seat; 24, sliding column; 25, roller; 3, detecting element; 4, outer frame; 5, beam; 6, connecting belt; 7, third drive assembly; 81, fourth gear; 82, fifth gear; 83, sixth gear; A, first direction.

### DETAILED DESCRIPTION

In order to enable a person skilled in the art to better understand the technical solutions in this application, the technical solutions in the embodiments of this application will be clearly and completely described below with reference to the accompanying drawings in the embodiments of this application. Obviously, the described embodiments are only a part of the embodiments of this application, but not all of the embodiments. Based on the embodiments in this application, all other embodiments obtained by a person skilled in the art without making creative efforts shall fall within the protection scope of this application.

It should be noted that when an element is referred to as being “fixed to” or “arranged on” another element, it can be directly on another element or indirectly on another element. When an element is referred to as being “connected to” another element, it can be directly connected to another element or indirectly connected to another element.

It should be understood that orientational or positional relationships represented by directional terms, such as “length”, “width”, “up”, “down”, “front”, “rear”, “left”, “right”, “vertical”, “horizontal”, “top”, “bottom”, “inside”, “outside”, etc., are orientational or positional relationships based on the drawings, and are merely for the convenience of describing this application and simplifying the description, rather than indicating or implying that the device or element is intended to have a particular orientation, or is constructed and operated in a particular orientation, and therefore, should not be interpreted as a limitation of this application.

In addition, terms such as “first” and “second” are used herein for purposes of description, and should not be interpreted as indication or implication of relative importance, or implied indication of a number of the technical features. Therefore, features limited by terms such as “first” and “second” can explicitly or impliedly include one or more than one of these features. In description of this application, the meaning of “multiple” and “plurality” is at least two or more, unless explicitly defined otherwise.

It should be noted that the structures, scales, sizes, etc., illustrated in the accompanying drawings of this specification are only intended to be considered in combination with those disclosed in the specification for the purpose of understanding and reading by those skilled in the art, and are not intended to limit the limitations to which the present application may be practiced, so they have no technical substantive significance. Any modification of structure, change of scale, or adjustment of size, without affecting the effect and purpose of this application, shall still fall within the scope of the technical content disclosed in this application.

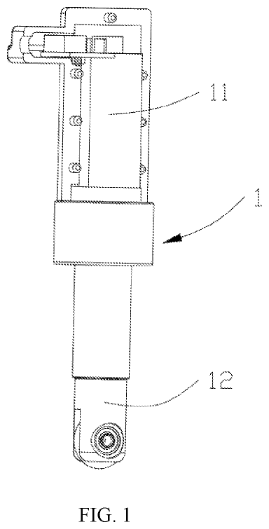

Referring to FIG. 1, in a first aspect, a cutter structure 1 is provided, which is applied to a travelling carriage assembly 2, and includes a first drive assembly 11 and a cutter 12. The first drive assembly 11 is capable of driving the cutter 12 to rotate relative to the first drive assembly 11.

It is worth noting that in the above-mentioned cutter structure 1, the first drive assembly 11 is integrated with the cutter 12, and the cutter structure 1 is applied to the travelling carriage assembly 2. The travelling carriage assembly 2 is an assembly in the cutting machine 10 configured to control the cutter structure 1 to advance or retract. In this application, a travelling carriage structure includes a cutter structure 1 configured for cutting and a travelling carriage assembly 2 configured for advancing/retracting. In addition, the first drive assembly 11 of the present application is preferably a servo motor.

In the conventional travelling carriage assembly 2 of the cutting machine 10, two motors are included therein, one is configured for driving the cutter 12 to advance/retract, and the other is configured for driving the cutter 12 to rotate so as to change the cutting angle. It is worth noting that, in the conventional technology, since the above two motors are both arranged inside the travelling carriage, when the motor configured for driving the cutter 12 to rotate fails, the transmission structure connected to the motor and the cutter 12 arranged outside the travelling carriage assembly 2 need to be removed first, then the cutting machine 10 and the travelling carriage assembly 2 need to be disassembled to replace the motor, then the travelling carriage assembly 2 and the cutting machine 10 need to be assembled, and finally the transmission structure and the cutter 12 need to be connected to the motor. The replacement process is very cumbersome.

In the present application, the cutter 12 and the servo motor are integrally assembled to form an integrated cutter structure 1, and the cutter structure 1 is fixed outside the travelling carriage assembly 2. The motor inside the travelling carriage assembly 2 can drive the cutter 12 to advance/retract, and the motor in the cutter structure 1 outside the travelling carriage assembly 2 can drive the cutter 12 to rotate. Therefore, the cutter structure 1 can achieve the same function as the conventional rotary cutting machine 10. Above all, when the motor configured for driving the cutter 12 to rotate needs to be replaced, the cutting machine 10 mounted with the cutter structure 1 of the present application only needs to replace the cutter structure 1. Compare with the conventional technology, this application integrates the first drive assembly 11 with the cutter 12, and it is only necessary to remove the integrated cutter 12 and replace it with a new cutter 12 to solve the problem of motor failure. This application has a simple and compact structure, and the replacement operation is very easy.

In addition, it is further worth noting that in different scenarios, cutters 12 with different rotating speeds for changing the cutting angles are required. However, the motor speed is usually fixed, so the rotating speed of the cutter 12 driven by the motor is also fixed. Therefore, in the present application, a motor with a certain rotating speed and a cutter 12 can be assembled into one cutter structure 1, and motors with different rotating speeds can also be assembled with the cutter 12 to form a plurality of cutter structures 1 with different rotating speeds. For example, the cutter structure 1 can be divided into a low-speed cutter structure 1, a medium-speed cutter structure 1, a high-speed cutter structure 1, etc., according to different motor speeds. When it is necessary to use the cutters 12 with different rotating speeds (this rotating speed refers to the speed at which the cutter 12 as a whole changes the cutting angle relative to the material to be cut, not the speed at which the blade rotates), for the conventional cutting machine 10, the transmission structure connected to the motor and the cutter 12 arranged outside the travelling carriage assembly 2 also need to be removed, then the cutting machine 10 and the travelling carriage assembly 2 are disassembled to replace the motors with different rotating speeds, then the travelling carriage assembly 2 and the cutting machine 10 are assembled, and finally the transmission structure and the cutter 12 are connected to the motor, and the operation process is very cumbersome. However, in the present application, the first drive assembly 11 and the cutters 12 are integrated, and it is only necessary to remove the cutter 12 with a certain current rotating speed and replace it with a cutter 12 with another rotating speed. The requirements of different cutting scenarios can be met, and the mounting is simple and convenient.

In addition, the present application provides for the miniaturization of the cutting machine 10 by arranging the motor originally arranged inside the cutting machine 10 in the cutter 12 outside the cutting machine 10, thereby reducing the space, inside the cutting machine 10, required for the motor and the transmission structure to which the motor is connected, as compared with the conventional technology.

In a preferred embodiment, the first drive assembly 11 is a servo motor.

It is worth noting that since the servo motor can control the rotating angle of the motor according to a control signal, the present application controls the rotating angle of the cutter 12 by controlling the rotation of the servo motor. A through hole is arranged on the motor housing 13, and the position of the through hole corresponds to the power supply interface of the servo motor. A power supply line in the travelling carriage can be connected to the power supply interface of the servo motor through the through hole to supply power to the servo motor.

In a preferred embodiment, the cutter structure 1 further includes a motor housing 13 assembled by two symmetrical half-motor housings, and an accommodating space formed in the motor housing 13 has a shape adapted to the shape of the servo motor.

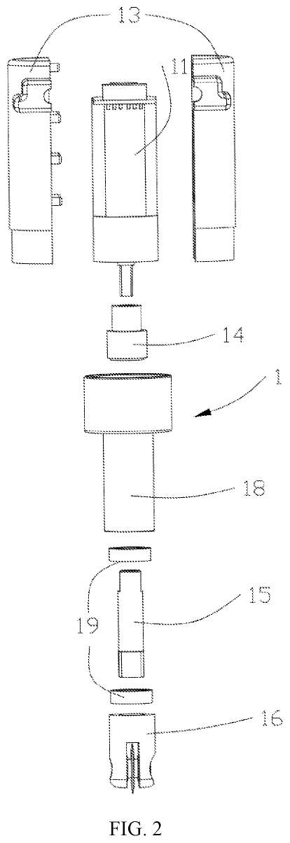

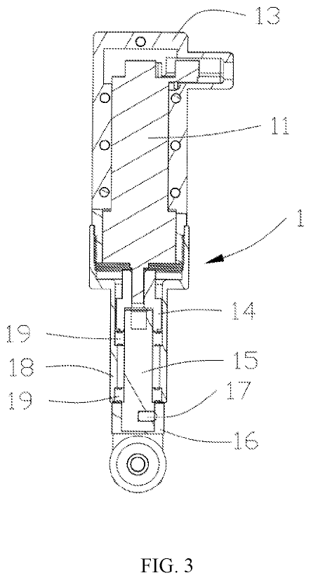

It is worth noting that referring to FIG. 2 and FIG. 3, the servo motor is arranged in the motor housing 13. The motor housing 13 is assembled by two half-motor housings, and an accommodating space is formed inside the motor housing 13 for accommodating the motor. The shape of the accommodating space is adapted to the shape of the servo motor. For example, when the servo motor is cylindrical, the accommodating space is also cylindrical, and the accommodating space is larger than the servo motor in volume. The housing assembled by the two half-housings is adapted to motors with various shapes, and during mounting, it is only necessary to mount the motor into one half-motor housing, and then mount the other half-motor housing. The two half-motor housings can be fixedly connected through the cooperation of the limiting block and the limiting hole.

In a preferred embodiment, the cutter structure 1 further includes a coupling 14. An end of the coupling 14 facing the servo motor is sleeved outside a rotating shaft of the servo motor, and another end of the coupling 14 facing the cutter 12 is fixedly connected to the cutter 12.

It is worth noting that, referring to FIGS. 2 and 3, the coupling 14 is a transmission structure, one end of which is connected to the rotating shaft of the motor, and the other end of which is connected to the cutter handle 15 in the cutter structure 1, so that the kinetic energy of the motor is transferred to the cutter structure 1 to drive the cutter structure 1 to rotate. One end of the coupling 14 is provided with a through hole corresponding to the rotating shaft of the motor, and the rotating shaft of the motor is inserted into the through hole to realize the fixed connection between the rotating shaft of the motor and the coupling 14. The other end of the coupling 14 is provided with a through hole corresponding to the cutter handle 15, and the cutter handle 15 of the cutter 12 is inserted into the through hole to realize the fixed connection between the cutter 12 and the coupling 14.

In a preferred embodiment, the cutter 12 includes a cutter handle 15 and a cutter head 16. An end of the cutter handle 15 facing the coupling 14 is fixedly connected to an end of the coupling 14 facing the cutter 12. The cutter head 16 is provided with a connecting hole at an end thereof facing the cutter handle 15, and the connecting hole is configured for fixing the cutter handle 15.

It is worth noting that, referring to FIGS. 2 and 3, the cutter 12 includes a cutter handle 15 and a cutter head 16. One end of the cutter handle 15 is inserted into the coupling 14, and the other end thereof is inserted into the cutter head 16. When the motor rotates, the kinetic energy is transferred to the cutter head 16 through the coupling 14 and the cutter handle 15, so that the cutter head 16 is driven to rotate to change the cutting angle. The cutter head 16 is provided with a connecting hole at an end surface thereof facing the cutter handle 15, and the cutter handle 15 is inserted into the connecting hole, so that the cutter handle 15 is fixedly connected to the cutter head 16. The lower end of the cutter head 16 is fixed with blades having different shapes and adapted to different cutting scenarios, for example, a tapered blade adapted for V-groove cutting and a circular blade adapted for ordinary cutting.

In a preferred embodiment, the cutter handle 15 is provided with an accommodating hole at an end thereof facing the cutter head 16, and the accommodating hole is configured for accommodating an elastic member 17. When the cutter handle 15 is inserted into the connecting hole, a portion of the elastic member 17 exposed from the accommodating hole applies pressure to an inner wall of the connecting hole.

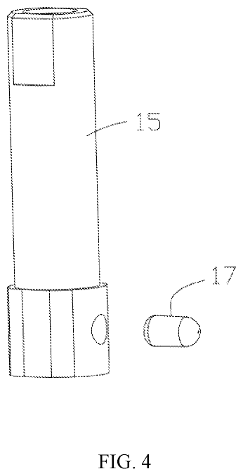

It is worth noting that, referring to FIGS. 3 and 4, an accommodating hole for accommodating the elastic member 17 is defined at the end of the cutter handle 15 facing the cutter head 16. The elastic member 17 is made of elastic materials such as rubber, silicone, or the like. When the cutter handle 15 is inserted into the connecting hole of the cutter head 16, there is a clearance between the cutter handle 15 and the cutter head 16. The portion of the elastic member 17 exposed from the accommodating hole has a depth greater than the clearance, so that the exposed portion of the elastic member 17 is pressed by the inner wall of the connecting hole to apply pressure to the inner wall of the connecting hole so as to better fix the cutter handle 15 and the cutter head 16.

In a preferred embodiment, the cutter structure 1 further includes a cutter housing 18 and a plurality of bearings 19. The cutter housing 18 is sleeved outside the coupling 14, one end of the cutter housing 18 is fixedly connected to the motor housing 13, and the other end thereof abuts against an end of the cutter head 16 facing the cutter handle 15. The plurality of bearings 19 are arranged in the cutter housing 18 and sleeved outside the cutter handle 15.

It is worth noting that, referring to FIGS. 2 and 3, an accommodating space is formed in the cutter housing 18, which can hide the cutter handle 15, the coupling 14, and a part of the motor. One end of the cutter housing 18 is fixedly connected to the motor housing 13, and the cutter housing 18 is fixedly connected to the motor housing 13 by means of threads. The other end of the cutter housing 18 abuts against an end surface of the cutter head 16 facing the cutter handle 15. The structure inside the cutter structure 1 is completely hidden by the motor housing 13, the cutter housing 18, and the cutter head 16.

In addition, it is further worth noting that, referring to FIGS. 2 and 3, a plurality of bearings 19 are sleeved outside the cutter handle 15. When the motor rotates to drive the coupling 14, the cutter handle 15, and the cutter head 16 to rotate, it will be affected by friction. The plurality of bearings 19 are sleeved outside the cutter handle 15, so that the friction and loss caused by the friction when the cutter handle 15 is rotated can be reduced.

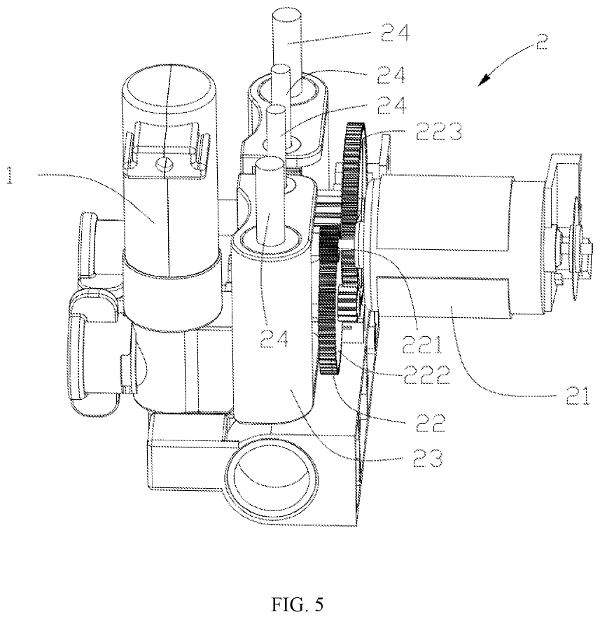

Referring to FIG. 5, in a second aspect, a travelling carriage structure is provided, including the cutter structure 1 of any of the above embodiments of the first aspect above. The cutter structure 1 is arranged on a travelling carriage assembly 2, and the travelling carriage assembly 2 is capable of driving the cutter structure 1 to move.

It is worth noting that, the travelling carriage structure includes a travelling carriage assembly 2 and a cutter structure 1 arranged on the travelling carriage assembly 2. The motor in the travelling carriage assembly 2 can drive the cutter structure 1 to move up and down to achieve advancing/retracting.

In a preferred embodiment, the travelling carriage assembly 2 includes a second drive assembly 21, a first transmission assembly 22, a seat 23, and a sliding column 24. The cutter structure 1 is fixed on the seat 23 (the cutter 12 may be fixed on the seat 23 by a fixing structure), and the seat 23 is sleeved on the sliding column 24. A side of a rotating shaft of the second drive assembly 21, which faces the seat 23, is provided with a first gear 221. The first gear 221 is engaged with a second gear 222, the second gear 222 is engaged with a third gear 223, and the third gear 223 is engaged with a rack 224 distributed on the seat 23 along a vertical direction. When the second drive assembly 21 drives the rotating shaft to rotate, the seat 23 is driven by the first gear 221, the second gear 222, the third gear 223, and the rack 224 to move along the sliding column 24.

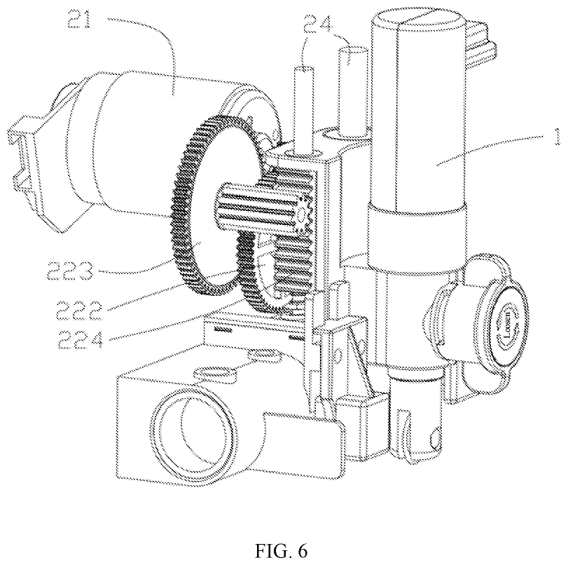

It is worth noting that, referring to FIGS. 5 and 6, the second drive assembly 21 is preferably an motor, and the first transmission assembly 22 includes a first gear 221, a second gear 222, a third gear 223, and a rack 224. The second gear 222 and the third gear 223 are duplex gears. A rotating shaft of the motor is directed toward the seat 23, and the first gear 221 is fixed on the rotating shaft. The first gear 221 is engaged with the large gear of the second gear 222, the pinion gear of the second gear 222 is engaged with the large gear of the third gear 223, and the pinion gear of the third gear 223 is engaged with the rack 224. When the motor rotates, the gear is capable of transferring kinetic energy to the seat 23 integrated with the rack 224, so as to drive the cutter structure 1 to move up and down, thereby achieving advancing/retracting. There may be one or two seats 23. When there are two seats 23, the motor rotates to move one cutter structure 1 upward and the other cutter structure 1 downward.

In a preferred embodiment, the cutter structure 1 is provided with a reflecting plane 181. The travelling carriage assembly 2 further includes a detecting element 3 which is arranged corresponding to the reflecting plane 181 so that when the cutter structure 1 is rotated to drive the reflecting plane 181 to a predetermined position, the detecting element 3 can detect light reflected by the reflecting plane 181.

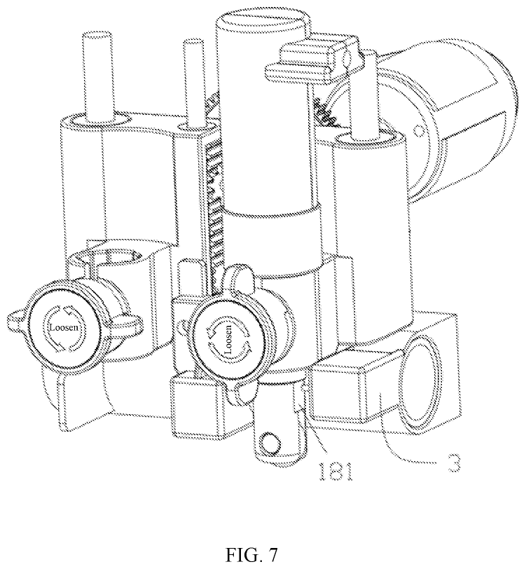

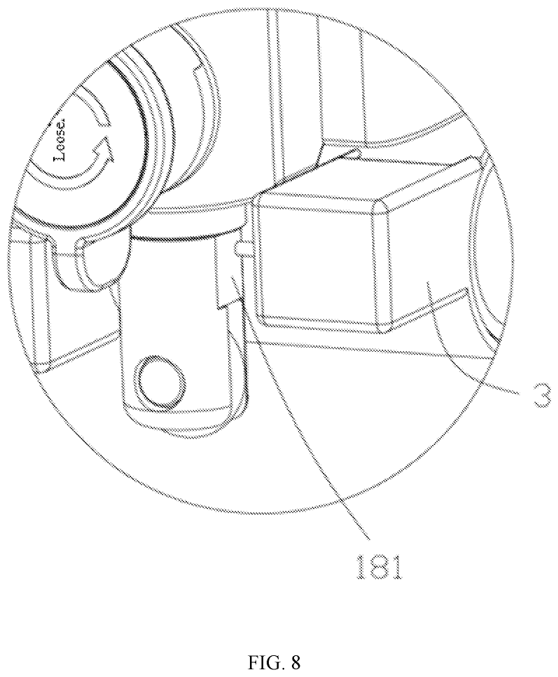

It is worth noting that, referring to FIGS. 7 and 8, a reflecting plane 181 is arranged on the cutter 12, a detecting element 3 is arranged on the travelling carriage assembly, and the detecting element 3 is arranged corresponding to the reflecting plane 181. The detecting element 3 can emit light. When the reflecting plane 181 is rotated to a certain position along with the cutter 12, the reflecting plane 181 reflects the light emitted by the detecting element 3. When the detecting element 3 detects the reflected light, the detecting element 3 outputs a signal to the controller. At this case, the controller clears parameters of the servo motor, and this position is positioned as a rotation origin. By providing the reflecting plane 181 and the detecting element 3, the rotating angle of the cutter 12 can be accurately known by using the reflecting plane 181 as the rotation origin, and the rotation of the cutter 12 can be accurately controlled.

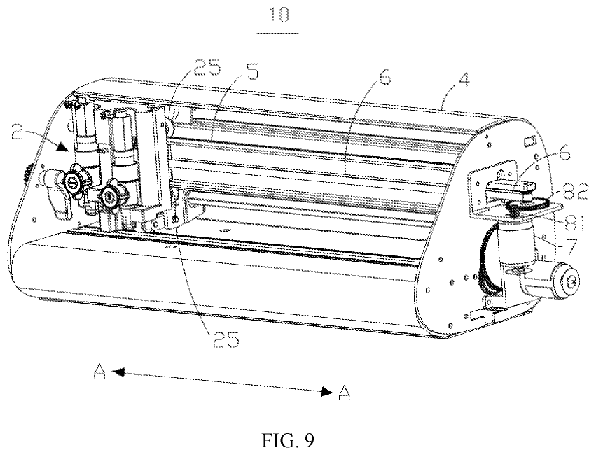

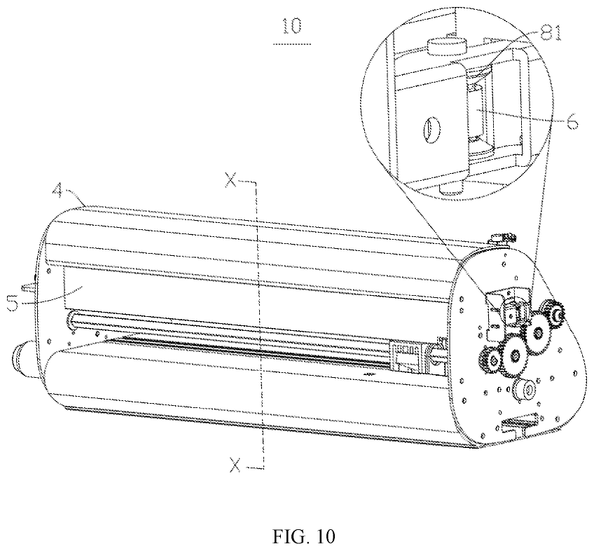

Referring to FIGS. 9 to 11, in a third aspect, a cutting machine 10 is provided, including the travelling carriage structure of any of the above embodiments of the second aspect. The motor is a servo motor, and the cutting machine 10 further includes a controller configured to control rotation of the first drive assembly 11 to change the angle of the cutter 12.

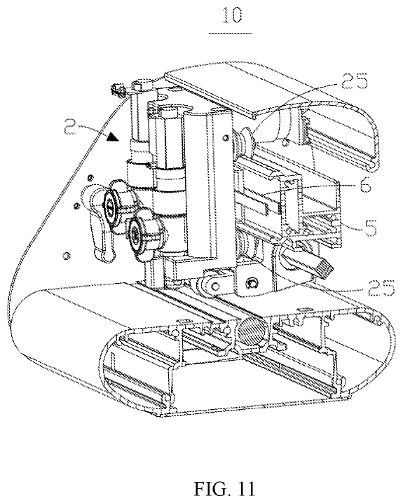

It is worth noting that, referring to FIGS. 9 and 11, the cutting machine 10 includes a cutter structure 1, a travelling carriage assembly 2, and motors for driving the travelling carriage assembly 2 to move along the X and Y axes, and a corresponding connecting structure. In addition, the cutting machine 10 further includes a controller, which is typically a programmable logic controller (PLC) or other elements having a control function, can control the rotation of each motor to control the rotation of the cutter structure 1, the advancing/retracting, and the movement of the cutter 12 along the X and Y axes.

In a preferred embodiment, in order to make the travelling carriage structure movable along a first direction A, the travelling carriage assembly 2 is provided with a plurality of rollers 25, and the cutting machine 10 further includes a beam 5 arranged on an outer frame 4. The rollers 25 are configured for slidably connecting the travelling carriage to the beam 5, and the plurality of rollers 25 are respectively arranged on both sides of the beam 5 and slidably connected to the beam 5. Specifically, there are four rollers 25, in which two rollers 25 are arranged on one side of the beam 5, and two rollers 25 are arranged on the other side of the beam 5. The length direction of the beam 5 is the first direction A. When the plurality of rollers 25 slide along the first direction A on the beam 5, the travelling carriage structure moves along the first direction A so that the cutter structure 1 moves along the first direction A with the travelling carriage.

In a preferred embodiment, in order to drive the travelling carriage structure to move along the first direction A, the cutting machine 10 further includes a connecting belt 6 and a second transmission assembly (not labeled) rotatably connected to the connecting belt 6. The second transmission assembly is arranged on the outer frame 4. A side of the connecting belt 6 is fixed on the travelling carriage. The second transmission assembly is capable of driving the connecting belt 6 to rotate to move the travelling carriage along the first direction A. Specifically, the second transmission assembly includes a third drive assembly 7, a fourth gear 81, a fifth gear 82, and a sixth gear 83. The third drive assembly 7 is preferably a motor. The connecting belt 6 is annular, and the inner wall of the connecting belt 6 is engaged with the fourth gear 81 and the fifth gear 82. The fifth gear 82 is engaged with the sixth gear 83. The fourth gear 81 is rotatably connected to one end of the outer frame 4 along the first direction A, and the fifth gear 82 is rotatably connected to the other end of the outer frame 4 along the first direction A. The sixth gear 83 is sleeved on the third drive assembly 7. In this way, when the third drive assembly 7 rotates, the third drive assembly 7 can drive the connecting belt 6 to rotate, thereby driving the travelling carriage to move along the first direction A.

According to the aforementioned cutter structure, the travelling carriage structure, and the cutting machine, firstly, the first drive assembly is connected to the cutter, so that the cutter can be driven to rotate by the first drive assembly, thereby achieving the function of changing the cutting direction. When the motor fails, for the conventional cutting machine, the transmission structure and the cutter need to be removed first, and then the cutting machine is disassembled to remove and replace the failed motor, and finally the transmission structure and the cutter are mounted. However, the present application integrates the first drive assembly with the cutter, and it is only necessary to remove the integrated cutter and replace it with a new cutter to solve the problem of motor failure. This application has a simple and compact structure, and the replacement operation is very easy.

In addition, when the cutting machine needs to change the rotating speed of the cutter to meet the needs of different scenarios, for the conventional cutting machine, the transmission structure and the cutter need to be removed first, and then the cutting machine is disassembled to replace the motors with different rotating speeds, and finally the transmission structure and the cutter are mounted. However, in the present application, the first drive assembly and the cutters are integrated, and it is only necessary to remove the cutter with a certain current rotating speed and replace it with a cutter with another rotating speed. In other words, the present application can configure the first drive assembly with different rotating speeds to assemble cutters with different rotating speed gears, so as to meet the needs of different cutting scenarios, and the mounting is simple and convenient.

Moreover, the present application provides for the miniaturization of the cutting machine by arranging the motor originally arranged inside the cutting machine in the cutter outside the cutting machine, thereby reducing the required space inside the cutting machine.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A cutter structure, applied to a travelling carriage assembly, comprising a first drive assembly and a cutter, the first drive assembly being capable of driving the cutter to rotate relative to the first drive assembly.

2. The cutter structure of claim 1, wherein the first drive assembly is a servo motor.

3. The cutter structure of claim 2, further comprising:
a motor housing, assembled by two symmetrical half-motor housings, wherein an accommodating space formed in the motor housing has a shape adapted to a shape of the servo motor.

4. The cutter structure of claim 3, further comprising:
a coupling, an end of the coupling facing the servo motor being sleeved outside a rotating shaft of the servo motor, and another end of the coupling facing the cutter being fixedly connected to the cutter.

5. The cutter structure of claim 4, wherein the cutter comprises:
a cutter handle, an end of the cutter handle facing the coupling being fixedly connected to an end of the coupling facing the cutter; and
a cutter head, wherein the cutter head is provided with a connecting hole at an end thereof facing the cutter handle, and the connecting hole is configured to fix the cutter handle.

6. The cutter structure of claim 5, wherein the cutter handle is provided with an accommodating hole at an end thereof facing the cutter head, and the accommodating hole is configured to accommodate an elastic member; when the cutter handle is inserted into the connecting hole, a portion of the elastic member exposed from the accommodating hole applies pressure to an inner wall of the connecting hole.

7. The cutter structure of claim 6, further comprising:
a cutter housing, sleeved outside the coupling, wherein one end of the cutter housing is fixedly connected to the motor housing, and the other end thereof abuts against an end of the cutter head facing the cutter handle; and
a plurality of bearings, arranged in the cutter housing and sleeved outside the cutter handle.

8. A travelling carriage structure, comprising a travelling carriage assembly and the cutter structure of claim 1, the cutter structure being arranged on the travelling carriage assembly, and the travelling carriage assembly being capable of driving the cutter structure to move.

9. The travelling carriage structure of claim 8, wherein the travelling carriage assembly comprises a second drive assembly, a first transmission assembly, a seat, and a sliding column; the cutter structure is fixed on the seat, the seat is sleeved on the sliding column; a side of a rotating shaft of the second drive assembly facing the seat is provided with a first gear; the first gear is engaged with a second gear, the second gear is engaged with a third gear, and the third gear is engaged with a rack distributed on the seat along a vertical direction; when the second drive assembly drives the rotating shaft to rotate, the seat is driven by the first gear, the second gear, the third gear, and the rack to move along the sliding column.

10. The travelling carriage structure of claim 9, wherein the cutter structure is provided with a reflecting plane; the travelling carriage assembly further comprises:
a detecting element, wherein the detecting element is arranged corresponding to the reflecting plane so that when the cutter structure is rotated to drive the reflecting plane to a predetermined position, the detecting element is capable of detecting light reflected by the reflecting plane.

11. A cutting machine, comprising the travelling carriage structure of claim 8 and a controller configured to control rotation of the first drive assembly to change an angle of the cutter.

12. The cutting machine of claim 11, wherein the travelling carriage assembly is provided with a plurality of rollers; the cutting machine further comprises an outer frame and a beam arranged on the outer frame, a length direction of the beam is provided along a first direction; the plurality of rollers are arranged on both sides of the beam and slidably connected to the beam, and are configured to enable the travelling carriage structure to move along the first direction.

13. The cutting machine of claim 12, further comprising:
a connecting belt, a side of the connecting belt being fixed on the travelling carriage; and
a second transmission assembly, rotatably connected to the connecting belt and arranged on the outer frame, the second transmission assembly being capable of driving the connecting belt to rotate to move the travelling carriage along the first direction.
